(19) United States
(12) Patent Application Publication
(10) Pub. No.: US 2003/0055636 A1
(43) Pub. Date: Mar. 20, 2003

(54) System and method for enhancing speech components of an audio signal

(75) Inventors: Naoyuki Katuo, Iizuka-Shi (JP); Yoshinori Kumamoto, Fukuoka-Ken (JP)

Correspondence Address: DARBY & DARBY P.C., P. O. BOX 5257, NEW YORK, NY, 10150-5257, US

(73) Assignee: Matsushita Electric Industrial Co., Ltd.

(21) Appl. No.: 10/245,838

(22) Filed: Sep. 16, 2002

(30) Foreign Application Priority Data
Sep. 17, 2001 (JP) 2001-280896

(51) Int. Cl. G10L 21/00; G10L 19/14

(52) U.S. Cl. 704/225; 704/278

(57) ABSTRACT

A gain adjustment unit uses a power ratio, Padd/Pdif, as an index for judging the strength of speech in an audio signal. Padd is the power of a sum signal of a left channel signal and a right channel signal, and Pdif is the power of the difference signal of the left channel signal and the right channel signal. When the power ratio is small, speech is absent from the audio signal and the gain of the sum signal of the left channel signal and right channel signal is minimized. As a result, it becomes possible to suppress a speech enhancement process when speech is absent from the audio signal to thereby eliminate negative effects associated therewith.

### BACKGROUND OF THE INVENTION

1. Field of the Invention

The present invention is directed to speech synthesis and, more particularly to a system and method for enhancing speech components of an audio signal.

2. Description of the Related Art

In conventional systems, the enhancement of stereo speech audio signals is achieved by using a left channel signal and a right channel signal to compute a sum signal (e.g., Xadd) and a difference signal (e.g., Xdif) of the left channel signal and the right channel signal as follows:

Xadd=L+R (Eq. 1)

Xdif=L−R (Eq. 2)

During reproduction of an audio signal, the speech component of the signal is maintained at the same level and phase in both the left and right channels so that the speech is localized at the center of the signal. In contrast, background sounds, such as instrumental sounds, gunshot sounds, and the like, are normally maintained at different levels and phases in both the left and right channels. As a result, the sum signal is a signal in which the speech is enhanced and the background sounds are attenuated. In the difference signal, however, only the background sounds are present, while the speech is absent from the difference signal.

Prior art methods for enhancing speech comprise adding a sum signal to signals that are obtained by multiplying an original left channel signal and right channel signal by a predetermined factor/value.

FIG. 22 is a block diagram of a prior-art speech component enhancement device for achieving such an enhancement of speech. As shown in FIG. 22, left channel signal Li is input into an input terminal 106. Multiplication unit 110, contained in sum signal generation unit 100, outputs a signal that is obtained by multiplying the left channel signal Li by a predetermined factor C. At the same time, right channel signal Ri is input into an input terminal 107. Multiplication unit 111, contained in sum signal generation unit 100, outputs a signal that is obtained by multiplying the right channel signal Ri by the predetermined factor C. Here, C is set, for example to “0.5.”

The output signal of multiplication unit 110 and the output signal of multiplication unit 111 are added together in addition unit 112, and are output as a sum signal to a multiplication unit 102.

A signal that is obtained by multiplying the sum signal by a predetermined factor b is output from multiplication unit 102 to addition units 104 and 105. Concurrently, a signal that is obtained by multiplying the left channel signal Li by a predetermined factor a is also output from multiplication unit 101 to addition unit 104.

A signal that is obtained by multiplying the right channel signal Ri by the predetermined factor a is also output from multiplication unit 103 to addition unit 105.

The output signal of multiplication unit 101 and the output signal of multiplication unit 102 are subsequently summed together, where the resultant signal is output as a new left channel signal Lo to an output terminal 108. Simultaneously, the output signal of multiplication unit 103 and the output signal of multiplication unit 102 are summed together in addition unit 105, where the resultant signal is output as a new right channel signal Ro to an output terminal 109.

Here, a is set to a number, such as “0.707,” and b is set to a number, such as “0.293.” The values of factor b and factor a determine the level of speech enhancement, where the greater the value of b, the higher the level of speech enhancement.

In such a prior-art speech component enhancement device, the sum signal having a same level and phase is added to each of the original left and right channel signals Ri, Li. As a result, the stereo image is reduced, while the monaural image is increased.

However, when speech is present in the audio signal, the degradation of the stereo image is quite unnoticeable because of the attention that is paid to the speech; when speech is not present, the loss of the stereo image due to the above-described side effect becomes noticeable.

### SUMMARY OF THE INVENTION

The present invention is directed to a system and a method for minimizing the side effects associated with speech enhancement so that stereo imagining during the absence of speech is maintained. In accordance with the invention, a speech component enhancement device is used to enhance center-localized speech components. The speech component enhancement device comprises: a sum signal generation unit, which generates a sum signal of a left channel signal and a right channel signal; a speech component adjustment unit, which references the left channel signal and the right channel signal and adjusts the gain of the sum signal based on the strength of a speech component; a first addition unit, which adds the sum signal that has been gain adjusted by the speech component adjustment unit and the left channel signal and outputs the result as a new left channel signal; and a second addition unit, which adds the sum signal that has been gain adjusted by the speech component adjustment unit and the right channel signal and outputs the result as a new right channel signal.

With this arrangement, the gain of the sum signal that is added to the left channel signal and the right channel signal can be adjusted based on the level of the speech in the audio signal.

As a result, the gain of the sum signal can be minimized when speech is not present in the audio signal, thereby reducing the side effects of the speech enhancement process and maintaining the stereo image when speech is present in the audio signal.

Concurrently, when speech is present in the audio signal, the gain of the sum signal can be maximized to enhance the speech and thereby permit the speech component enhancement device to perform its primary function.

In an aspect of the invention, the speech component adjustment unit comprises: a sum signal power calculation unit, which calculates the power of a sum signal of the left channel signal and the right channel signal; a difference signal power calculation unit, which calculates the power of a difference signal of the left channel signal and the right channel signal; and a gain adjustment unit, which references the ratio of the power of the sum signal and the power of the difference signal to adjust the gain of the sum signal generated by the sum signal generation unit based on the level of the speech component in the audio signal.

In accordance with this aspect, by using the ratio of the power of the sum signal and the power of the difference signal as an index, it becomes possible to accurately determine the level of the speech component in the audio signal.

In another aspect of the invention, the speech component adjustment unit comprises: a sum signal power calculation unit, which calculates the power of a sum signal of the left channel signal and the right channel signal; an LR average power calculation unit, which calculates an average value of the power of the left channel signal and the power of the right channel signal; and a gain adjustment unit, which references the ratio of the power of the sum signal and the average value calculated by the LR average power calculation unit to adjust the gain of the sum signal that is generated by the sum signal generation unit based on the level of the speech component in the audio signal.

As configured in this aspect, the invention permits the use of the ratio of the power of the sum signal and the average value calculated by the LR average power calculation unit as an index to thereby accurately determine the level of the speech component in the audio signal.

In another aspect of the invention, the sum signal power calculation unit comprises: an addition unit, which generates a sum signal of the left channel signal and the right channel signal; a band-pass filter, having a voice frequency band as the pass band; and a power calculation unit, which calculates the power of the sum signal that has passed through the band-pass filter.

With this arrangement, it becomes possible to minimize increases of the power of the sum signal that occurs because of background sound components other than the speech components that are contained in the sum signal.

As a result, by using the ratio of the power of the sum signal and the difference signal or the ratio of the power of the sum signal and the power of the average value calculated by an LR average power calculation unit as an index, it becomes possible to more accurately determine the level of the speech component in the audio signal.

In an additional aspect of the invention, the sum signal power calculation unit comprises: band-pass filters, each having a voice frequency band as the pass band; an addition unit, which generates a sum signal of the left channel signal that has passed through a band-pass filter and the right channel signal that has passed through a band-pass filter; and a power calculation unit, which calculates the power of the sum signal generated by the addition unit.

With this aspect, it becomes possible to minimize background sound components other than the speech component that are contained in the left channel signal and the right channel signal. In this case, the background sound components that are contained in the sum signal are practically eliminated. In addition, the increase of the power of the sum signal due to the effect of background sound components can be greatly reduced. As a result, by using the ratio of the power of the sum signal and the power of the difference signal or the ratio of the power of the sum signal and the average value calculated by the LR average power calculation unit as an index, it becomes possible to more accurately determine the level of the speech component in the audio signal.

In a further aspect of the invention, the gain adjustment unit uses the ratio of the power of the sum signal and the power of the difference signal as an index for determining the strength of the speech component and the gain adjustment unit adjusts the gain of the sum signal generated by the sum signal generation unit to a magnitude that is based on the magnitude of the index.

This aspect eliminates the need to set the gain of the sum signal that is generated by the sum signal generation unit subsequent to comparisons of situations in which speech has occurred and situations in which speech has not occurred. As a result, the difficulties associated with accurately determining whether or not speech has occurred are avoided.

In an additional aspect of the present invention, the gain adjustment unit uses the ratio of the power of the sum signal and the average value calculated by an LR average power calculation unit as an index for determining the magnitude of the speech component and the gain adjustment unit adjusts the gain of the sum signal generated by the sum signal generation unit to a magnitude that is in accordance with the magnitude of the index.

This aspect also eliminates the need to set the gain of the sum signal that is generated by the sum signal generation unit pursuant to comparisons of situations in which speech has occurred and situations in which speech has not occurred. As a result, the difficulties associated with accurately determining whether or not speech has occurred are avoided.

### BRIEF DESCRIPTION OF THE DRAWINGS

The above foregoing and other advantages and features of the invention will become apparent from the following description read in conjunction with the accompanying drawings, in which like reference numerals designate the same elements.

FIG. 1 is a block diagram of a speech component enhancement device in accordance with the invention;

FIG. 2 is a graphical plot of a gain setting process performed by a gain adjustment unit of FIG. 1;

FIG. 3 is an exemplary mathematical relationship that is used in the gain setting process by the gain adjustment unit of FIG. 1;

FIG. 4 is an exemplary Table that is used in the gain setting process by the gain adjustment unit of FIG. 1;

FIG. 5(a) is an exemplary block diagram of a sum signal power calculation unit of FIG. 1;

FIG. 5(b) is an alternative embodiment of the sum signal power calculation unit of FIG. 1;

FIG. 5(c) is another embodiment of the sum signal power calculation unit of FIG. 1;

FIG. 6(a) is an exemplary block diagram of a power calculation unit of FIG. 1;

FIG. 6(b) is an alternative embodiment of the power calculation unit of FIG. 1;

FIG. 7 is an exemplary block diagram of a difference signal power calculation unit of FIG. 1;

FIG. 8 is an exemplary block diagram of a sum signal generation unit of FIG. 1;

FIG. 9 is a block diagram of an alternative embodiment of the speech component enhancement device of FIG. 1;

FIG. 10 is a block diagram of another embodiment of the speech component enhancement device of FIG. 9;

FIG. 11 is a block diagram of an alternative embodiment of the speech component enhancement device of FIG. 1;

FIG. 12 is a block diagram of another embodiment of the speech component enhancement device of FIG. 1;

FIG. 13 is a block diagram of another embodiment of the speech component enhancement device in accordance with the invention;

FIG. 14 is an exemplary block diagram of a LR average power calculation unit of FIG. 13.

FIG. 15 is a graphical plot of a gain setting process performed by a gain adjustment unit of FIG. 13;

FIG. 16 is an exemplary mathematical relationship that is used in the gain setting process by the gain adjustment unit of FIG. 13;

FIG. 17 is an exemplary Table that is used in the gain setting process by the gain adjustment unit of FIG. 13;

FIG. 18 is a block diagram of an alternative embodiment of the speech component enhancement device of FIG. 13;

FIG. 19 is a block diagram of another embodiment of the speech component enhancement device of FIG. 13;

FIG. 20 is a block diagram of a further embodiment of the speech component enhancement device of FIG. 13;

FIG. 21 is a block diagram of another embodiment of the speech component enhancement device of FIG. 13; and

FIG. 22 is a block diagram of a prior-art speech component enhancement device.

### DETAILED DESCRIPTION OF THE EXEMPLARY EMBODIMENTS

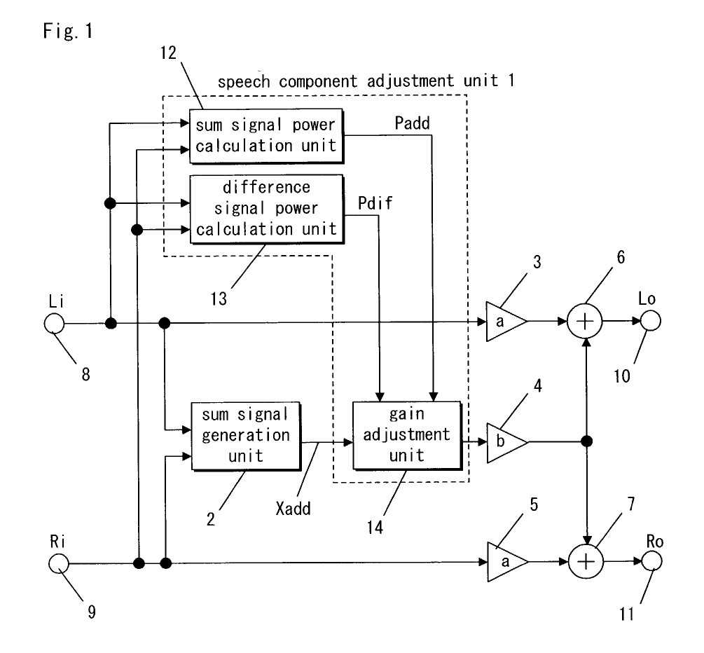

FIG. 1 is a block diagram of a speech component enhancement device in accordance with the invention. As shown in FIG. 1, the speech component enhancement device is equipped with a speech component adjustment unit 1, sum signal generation unit 2, multiplication units 3, 4, and 5, addition units 6 and 7, input terminals 8 and 9, and output terminals 10 and 11.

In addition, speech component adjustment unit 1 includes a sum signal power calculation unit 12, difference signal power calculation unit 13, and gain adjustment unit 14.

In accordance with the invention, a left channel signal Li is input into input terminal 8. A right channel signal Ri is input into input terminal 9. Sum signal generation unit 2 receives the left channel signal Li and the right channel signal Ri and generates a sum signal (e.g., Xadd).

With further reference to FIG. 1, sum signal power calculation unit 12 calculates the power of the sum signal of the left channel signal Li and the right channel signal Ri. Difference signal power calculation unit 13 calculates the power of a difference signal (e.g., Pdif) of the left channel signal Li and the right channel signal Ri.

Gain adjustment unit 14 adjusts the gain of the sum signal that is generated by sum signal generation unit 2 based on the ratio of the power of the signals that are respectively output from the sum signal power calculation unit 12 and the difference signal power calculation unit 13.

Multiplication unit 4 multiplies the gain-adjusted sum signal by a predetermined factor b. Multiplication unit 3 multiplies the left channel signal Li by a predetermined factor a. Multiplication unit 5 multiplies the right channel signal Ri by the predetermined factor a.

Addition unit 6 is used to add the output signal of multiplication unit 3 and the output signal of multiplication unit 4, and output a resultant signal as a new left channel signal Lo to output terminal 10.

Concurrently, addition unit 7 adds the output signal of multiplication unit 5 and the output signal of multiplication unit 4, and outputs a resultant signal as a new right channel signal Ro to output terminal 11. Here, the left channel signal (e.g. Lo) is output from output terminal 10, while the right channel signal (e.g., Ro) is output from output terminal 11.

In accordance with the invention, stereo audio signals are input to input terminals 8 and 9. More specifically, left channel signal Li is input into input terminal 8 and right channel signal Ri is input into input terminal 9.

The left channel signal Li is then input into sum signal power calculation unit 12, difference signal power calculation unit 13, and sum signal generation unit 2. The right channel signal Ri is then input into sum signal power calculation unit 12, difference signal power calculation unit 13, and sum signal generation unit 2.

Sum signal power calculation unit 12 calculates the power level of the sum signal of the left channel signal Li and the right channel signal Ri, and provides a calculated result to gain adjustment unit 14.

Difference signal power calculation unit 13 calculates the power level of the difference signal of the left channel signal Li and right channel signal Ri and provides a calculated result to gain adjustment unit 14.

Gain adjustment unit 14 adjusts the gain of the sum signal that is generated by sum signal generation unit 2, and outputs the resultant signal to multiplication unit 4. Here, the ratio of the power level of the sum signal to the power level of the difference signal; that is, a power ratio, e.g., Padd/Pdif, is used as an index for determining the level of the speech component, and the gain of the sum signal is set to a magnitude that is based on the magnitude of the power ratio.

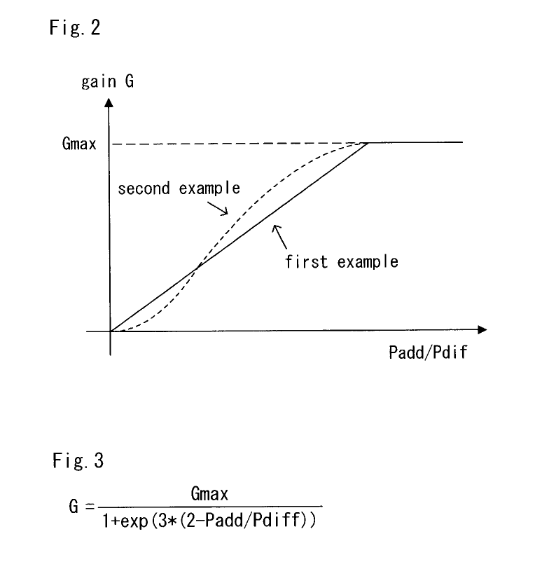

FIG. 2 is a graphical plot of the adjustment of the gain of the sum signal by gain adjustment unit 14. In FIG. 2, the ordinate axis y indicates the gain of the sum signal that is set by gain adjustment unit 14 and the abscissa axis x indicates the power ratio, i.e., Padd/Pdif.

As shown in FIG. 2, based on the first exemplary plot (i.e., the solid line), gain adjustment unit 14 sets the gain of the sum signal such that the gain of the sum signal is proportional to the magnitude of the power ratio, i.e., Padd/Pdif.

However, whereas Padd/Pdif varies from 0 to infinity, the gain is set so as to saturate at a maximum value, such as Gmax. With gain adjustment unit 14, the maximum value, i.e., Gmax, is set to a predetermined value so that the gain of the sum signal will not exceed the maximum value established as Gmax. In certain embodiments, Gmax is set to “1.”

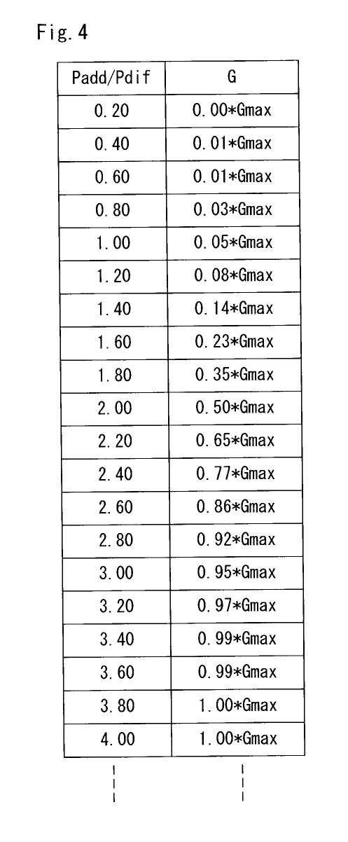

In addition, based on the second exemplary plot (i.e., the dashed line), the gain of the sum signal may be set such that it increases in a curvilinear manner with an increase in the power ratio, i.e., Padd/Pdif. However, even in this case, a maximum value for the gain is set in a manner similar to when the gain of the sum signal is proportional to the magnitude of the power ratio Here, gain adjustment unit 14 may set the gain of the sum signal in accordance with the exemplary relationship shown in FIG. 3. Alternatively, the gain of the sum signal may be set by using a number from the exemplary table shown in FIG. 4. Here, the gain for a point that is not provided in the table may be determined by linear interpolation or another interpolation process.

Gain adjustment unit 14 thus sets the magnitude of the gain of the sum signal based on the magnitude of the power ratio so that the magnitude is large when the power ratio is large, and so that the magnitude is small when the power ratio is small, where the maximum value, i.e., Gmax is the limit for the magnitude of the gain of the sum signal.

As long as the gain of the sum signal is set in such a manner, the relationship between the gain and power ratio is not limited to the exemplary graphical plots shown in FIG. 2.

When speech occurs, the power of the sum signal will be large, and relative to the power of the difference signal the power of the sum signal will also be large. As a result, a large power ratio provides an indication that speech has occurred, or is occurring. Conversely, a small power ratio provides an indication that speech has not occurred, or is not occurring. As a result, it is possible to use the power ratio as an index for determining the level of speech in an audio signal.

Accordingly, by setting the gain of the sum signal to a small value when the power ratio is small, as shown in FIG. 2, the speech enhancement process can be suppressed when speech is absent from the audio signal. As a result, when speech is not present in the signal, the side effect of the speech enhancement process described in accordance with the prior art can be suppressed, and the stereo image can be maintained.

At the same time, by setting the gain of the sum signal to a large value when the power ratio is large as shown in FIG. 2, it is possible to enhance speech as it occurs. As a result, the speech component enhancement process will be permitted to performs its primary function.

However, the gain is not set by a rigid comparison of a case in which speech occurs and a case in which speech does not occur. Rather, the gain of the sum signal is increased and decreased in a continuous manner in accordance with the magnitude of the power ratio shown in FIG. 2.

Accordingly, the gain of the sum signal is not set upon comparisons between a case in which speech occurs and a case in which speech does not occur. As a result, the difficulties associated with the process of systematically determining whether or not speech occurs or is occurring are avoided.

Returning now to FIG. 1, in accordance with the invention, gain adjustment unit 14 adjusts the gain of the sum signal that is generated by sum signal generation unit 2 and outputs the resultant signal to multiplication unit 4.

Multiplication unit 4 outputs a signal to addition units 6 and 7 that is obtained by multiplying the sum signal by a predetermined factor b.

Multiplication unit 3 outputs a signal to addition unit 6 that is obtained by multiplying the left channel signal Li by a predetermined factor a. Multiplication unit 5 outputs a signal to addition unit 7 that is obtained by multiplying the right channel signal Ri by the predetermined factor a.

Addition unit 6 adds the output signal of multiplication unit 3 and the output signal of multiplication unit 4 and outputs the resultant signal as a new left channel signal Lo to output terminal 10. Concurrently, addition unit 7 adds the output signal of multiplication unit 5 and the output signal of multiplication unit 4 and outputs the resultant signal as a new left channel signal Ro to output terminal 11. In certain embodiments, factor a is set to “0.707” and factor b is set to “0.293.” Here, the value of factor b and factor a determine the degree of speech enhancement, where the greater the value of factor b, the greater the degree of speech enhancement.

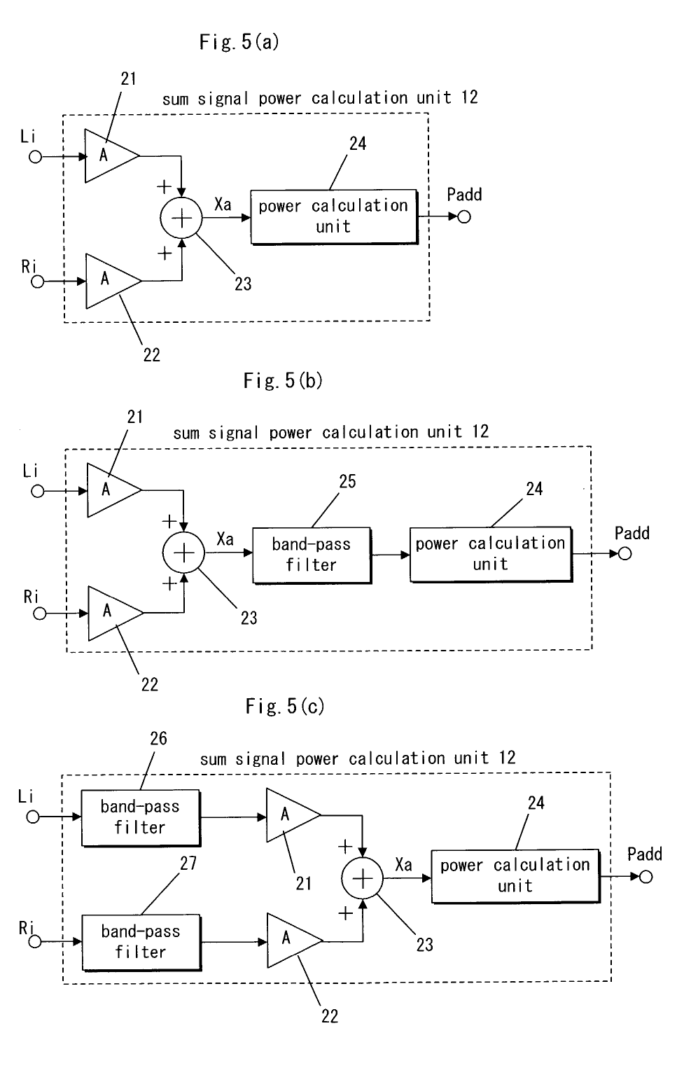

FIGS. 5(a) thru 5(c) are block diagrams of the sum signal power calculation unit 12 of FIG. 1. Here, FIG. 5(a) is an embodiment of a sum signal power calculation unit 12, FIG. 5(b) shows another embodiment of the sum signal power calculation unit 12, and FIG. 5(c) is a further embodiment of the sum signal power calculation unit 12.

The embodiment of the sum signal power calculation unit 12 shown in FIG. 5(a) includes multiplication units 21 and 22, addition unit 23, and power calculation unit 24. In the present embodiment, multiplication unit 21 multiplies the input left channel signal Li by a predetermined factor A, and outputs the resultant signal to addition unit 23. Concurrently, multiplication unit 22 multiplies the input right channel signal Ri by the predetermined factor A, and outputs the resultant signal to addition unit 23.

Addition unit 23 adds the output signal of multiplication unit 21 and the output signal of multiplication unit 22 and outputs the resultant as a sum signal (e.g., Xa) to power calculation unit 24. Power calculation unit 24 then calculates the power of the sum signal that is output by addition unit 23, and outputs the calculated value to gain adjustment unit 14 of FIG. 1. This power calculation unit 24 shall be described in more detail later.

The embodiment of the sum signal power calculation unit 12 shown in FIG. 5(b) includes multiplication units 21 and 22, addition unit 23, band-pass filter 25, and power calculation unit 24. The components in FIG. 5(b) that are identical to those in FIG. 5(a) are provided with the same symbols and descriptions thereof are omitted where appropriate.

That is, the present embodiment includes, in addition to the components in the sum signal power calculation unit 12 shown in FIG. 5(a), a band-pass filter 25 that is provided between addition unit 23 and power calculation unit 24. As a result, the sum signal that is output by addition unit 23 is passed through band-pass filter 25 and then input into power calculation unit 24.

The pass band of band-pass filter 25 is set to the voice frequency band. By limiting the power calculation of sum signal to the voice frequency band, the power of the sum signal is prevented from increasing due to the effects of instrumental sounds, gunshot sounds, and other background sound components that are contained in the sum signal, separately from the speech components.

The embodiment of the sum signal power calculation unit 12 shown in FIG. 5(c) includes band-pass filters 26 and 27, multiplication units 21 and 22, addition unit 23, and power calculation unit 24. The components in FIG. 5(c) that are identical to those in FIG. 5(a) are provided with the same symbols and descriptions thereof are omitted where appropriate.

That is, the present embodiment includes, in addition to the components in the sum signal power calculation unit 12 shown in FIG. 5(a), a band-pass filter 26 that is disposed at a stage prior to multiplication unit 21 and a band-pass filter 27 that is disposed at a stage prior to multiplication unit 22.

As a result, the left channel signal Li is input into multiplication unit 21 upon passing through band-pass filter 26. At the same time, the right channel signal Ri is input into multiplication unit 22 upon passage through band-pass filter 27.

As with the band-pass filter 25 of FIG. 5(b), the pass bands of the band-pass filters 26 and 27 of the present embodiment are set to the voice frequency band. This provides the same effect as discussed with respect to the power calculation unit 12 shown in FIG. 5(b).

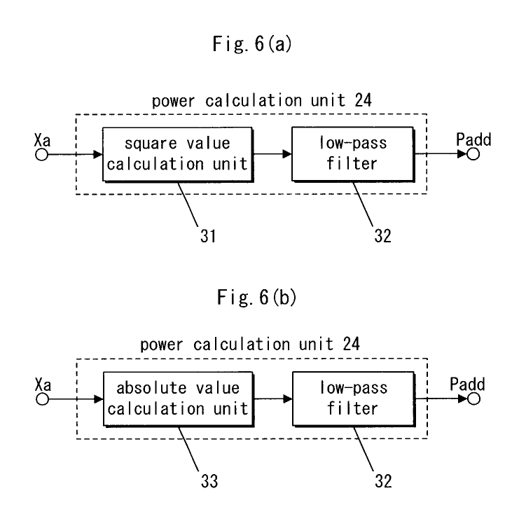

FIGS. 6(a) and 6(b) are illustrations of the power calculation unit 24 of FIGS. 5(a) thru 5(c). Here, FIG. 6(a) is a block diagram of an embodiment of the power calculation unit 24 and FIG. 6(b) is a block diagram of another embodiment of the power calculation unit 24.

The embodiment of the power calculation unit 24 shown in FIG. 6(a) includes a square value calculation unit 31 and a low-pass filter 32. The square value calculation unit 31 squares input signals to calculate the square value of the signal. In this case, the square value is the power of the input signal.

With further reference to FIG. 6(a), square value calculation unit 31 receives the sum signal that is output by addition unit 23 of FIGS. 5(a) thru 5(c) and calculates its square value to determine the power of the sum signal. In the embodiment shown in FIG. 5(b), square value calculation unit 31 receives the sum signal that has passed through band-pass filter 25.

Square value calculation unit 31 outputs the determined power of sum signal to low-pass filter 32. The power value of the sum signal calculated by square value calculation unit 31 passes through low-pass filter 32 and is input as a power value into gain adjustment unit 14 of FIG. 1.

The low-pass filter 32 minimizes instantaneous fluctuations of the input signal, and prevents the gain adjustments by gain adjustment unit 14 from becoming excessively loud to the human ear.

The embodiment of the power calculation unit 2 shown in FIG. 6(b) includes an absolute value calculation unit 33 and a low-pass filter 32. As before, the components in FIG. 6(b) that are identical to those in FIG. 6(a) are provided with the same symbols and descriptions thereof shall be omitted where appropriate.

Absolute value calculation unit 33 calculates the absolute value of the input signal. In FIG. 6(b), the absolute value is the power of the input signal. Absolute value calculation unit 33 receives the sum signal that is output by addition unit 23 of FIGS. 5(a) thru 5(c) and calculates its absolute value to determine the power of the sum signal.

With further reference to FIG. 6(b), upon determination of the power value of the sum signal, absolute value calculation unit 33 outputs the power value of the sum signal to low-pass filter 32. The power value of the sum signal calculated by absolute value calculation unit 33 is passed through low-pass filter 32, and is input as a power value to gain adjustment unit 14 of FIG. 1.

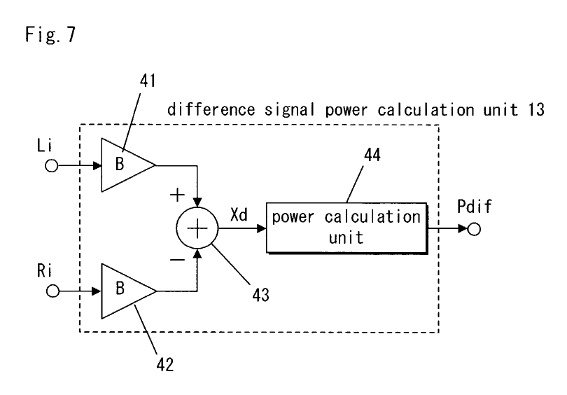

FIG. 7 is an exemplary block diagram of a difference signal power calculation unit of FIG. 1. As shown in FIG. 7, difference power calculation unit 13 includes multiplication units 41 and 42, addition unit 43, and power calculation unit 44.

Multiplication unit 41 multiplies the input left channel signal Li by a predetermined factor B and outputs the resultant signal to addition unit 43. Concurrently, multiplication unit 42 multiplies the input right channel signal Ri by the predetermined factor B and outputs the resulting signal to addition unit 43.

Addition unit 43 subtracts the output signal of multiplication unit 42 from the output signal of multiplication unit 41 and outputs the resultant signal as a difference signal to power calculation unit 44 that then calculates the power of the difference signal output by addition unit 43 and outputs the calculated power value to gain adjustment unit 14 of FIG. 1. The arrangement of this power calculation unit 44 is identical to the arrangement of power calculation unit 24 of FIGS. 6(a) and 6(b).

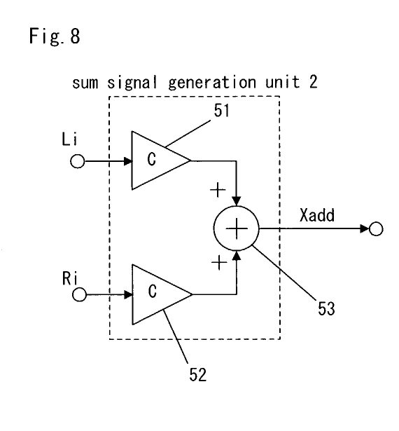

FIG. 8 is an exemplary block diagram of a sum signal generation unit of FIG. 1. As shown in FIG. 8, sum signal generation unit 2 includes multiplication units 51 and 52 and addition unit 53.

Multiplication unit 51 multiplies the input left channel signal Li by a predetermined factor C, and outputs the resultant signal to addition unit 53. At the same time, multiplication unit 52 multiplies the input right channel signal Ri by the predetermined factor C, and outputs the resultant signal to addition unit 53. In certain embodiments, C is set to “0.5.”

Addition unit 53 adds the output signal of multiplication unit 51 and the output signal of multiplication unit 52, and outputs the resultant signal as the sum signal to gain adjustment unit 14.

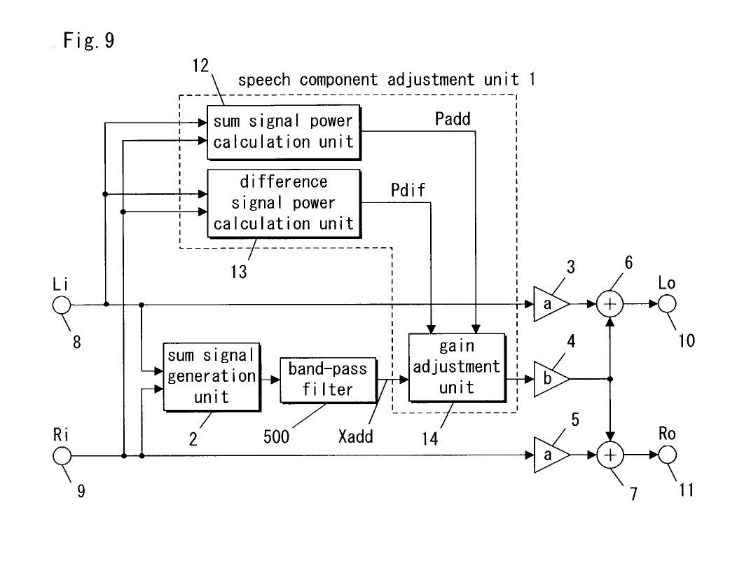

FIG. 9 is a block diagram of an alternative embodiment of the speech component enhancement device of FIG. 1. The components of FIG. 9 that are identical to those in FIG. 1 are provided with the same symbols. The embodiment shown in FIG. 9 includes a band-pass filter 500 having a voice frequency band as the pass band that is disposed between sum signal generation unit 2 and gain adjustment unit 14 of the speech component enhancement device of FIG. 1.

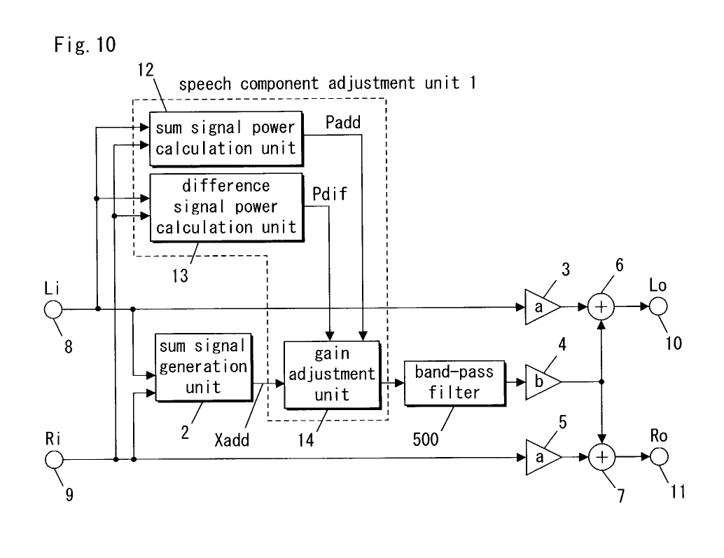

FIG. 10 is a block diagram of another embodiment of the speech component enhancement device of FIG. 9. Here, the components in FIG. 10 that are identical to those in FIG. 1 are provided with the same symbols. The embodiment shown in FIG. 10 includes a band-pass filter 500 having a voice frequency band as the pass band that is disposed between gain adjustment unit 14 and multiplication unit 4 of the speech component enhancement device of FIG. 1.

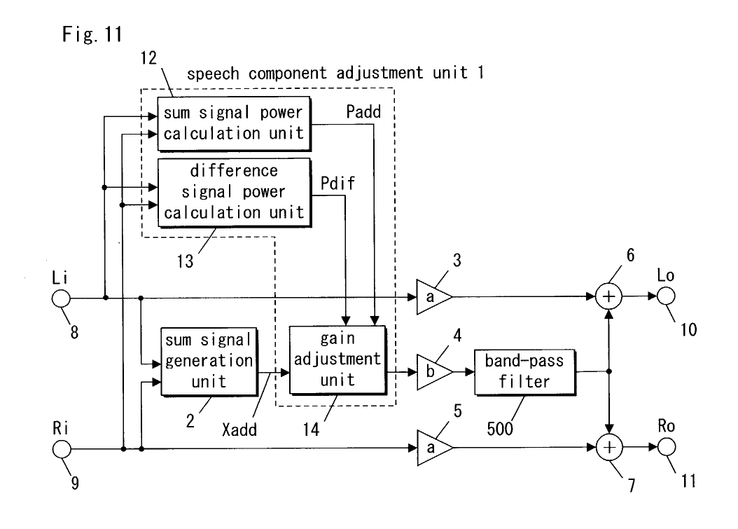

FIG. 11 is a block diagram of an alternative embodiment of the speech component enhancement device of FIG. 1. As before, the components in FIG. 11 that are identical to those in FIG. 1 are provided with the same symbols. As shown in FIG. 11, the present alternative embodiment includes a band-pass filter 500 having a voice frequency band as the passing band that is disposed at a stage that is subsequent to multiplication unit 4 of the speech component enhancement device of FIG. 1.

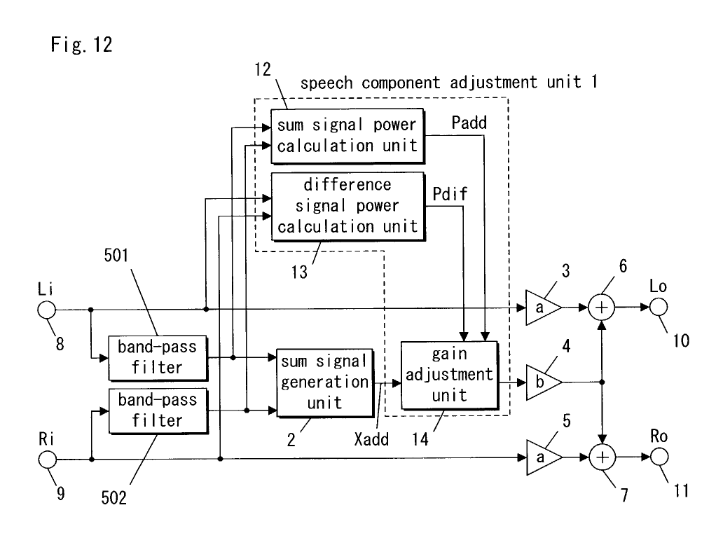

FIG. 12 is a block diagram of another embodiment of the speech component enhancement device of FIG. 1. The components in FIG. 12 that are identical to those in FIG. 1 are provided with the same symbols. As shown in FIG. 12, the present embodiment includes a band-pass filter 501 having a voice frequency band as the pass band that is disposed between input terminal 8 and sum signal generation unit 2 of the speech component enhancement device of FIG. 1, and a band-pass filter 502 having a voice frequency band as the pass band that is disposed between input terminal 9 and sum signal generation unit 2 of the speech component enhancement device of FIG. 1.

By providing band-pass filters 501 and 502, each having a voice frequency band as the pass band, at stages prior to the sum signal generation unit 2 or by providing a band-pass filter 500 having a voice frequency band as the pass band at a stage subsequent to the sum signal generation unit 2 (as in the prior embodiments), the frequency band of the signal that is added by addition units 6 and 7 to the output signals of multiplication units 3 and 5 can be restricted to the voice frequency band. As a result, it becomes possible to greatly minimize the enhancement of non speech components.

It should be noted that although the prior embodiments and modifications thereof were applied to two channels stereo signals, the present invention is not limited thereto and may be applied to multiple channels of stereo signals. For example, in the case of 5.1 channels, the same effects as those described above may be obtained by inputting the front left channel signal into input terminal 8 and the front right channel signal into input terminal 9.

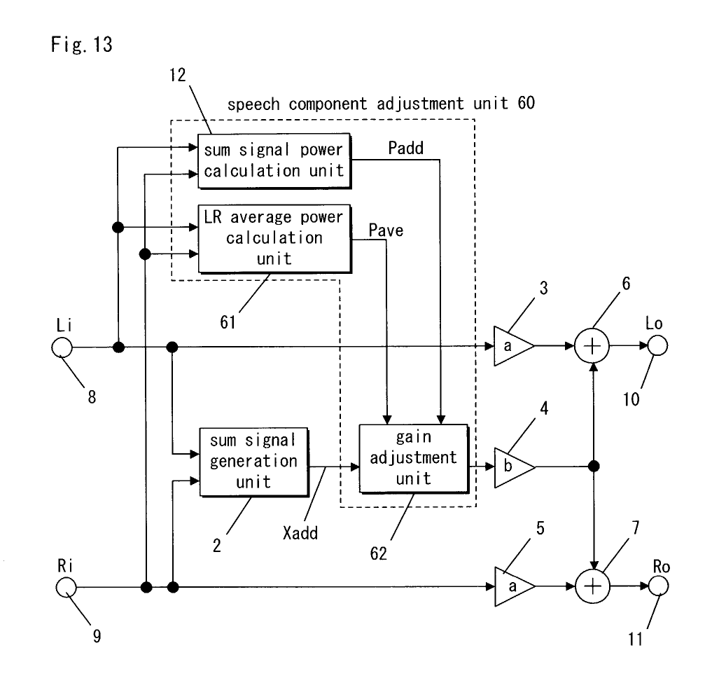

FIG. 13 is a block diagram of another embodiment of the speech component enhancement device in accordance with the invention. The components in FIG. 13 that are identical to those in FIG. 1 are provided with the same symbols and descriptions thereof are omitted where appropriate. As shown in FIG. 13, the speech component enhancement device is provided with a speech component adjustment unit 60 in place of the speech component adjustment unit 1 of the speech component enhancement device of FIG. 1.

Continuing with FIG. 13, speech component adjustment unit 60 includes a sum signal power calculation unit 12, LR average power calculation unit 61, and gain adjustment unit 62.

LR average power calculation unit 61 receives a left channel signal Li and a right channel signal Ri, calculates the average value (LR average power Pave) of the power of the left channel signal Li and the right channel signal Ri, and provides the calculated result to gain adjustment unit 62.

The gain adjustment unit 62 adjusts the gain of the sum signal that is generated by sum signal generation unit 2, and outputs the resultant signal to multiplication unit 4. Here, the ratio of the power of the sum signal and the LR average power, i.e., the power ratio Padd/Pave, is used as an index for determining the level of speech and the gain of the sum signal is set to a magnitude based on the magnitude of the power ratio.

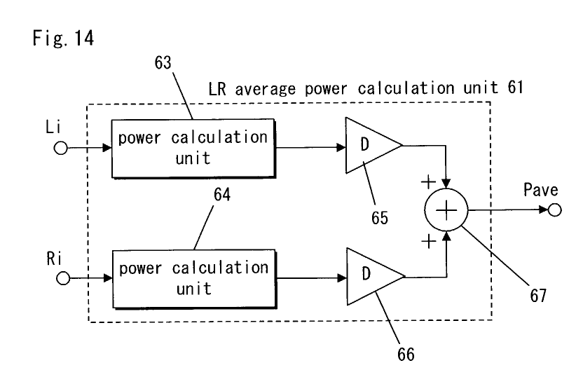

FIG. 14 is an exemplary block diagram of a LR average power calculation unit of FIG. 13. As shown in FIG. 14, LR average power calculation unit 61 includes power calculation units 63 and 64, multiplication units 65 and 66, and addition unit 67.

Power calculation unit 63 calculates the power of the input left channel signal Li and outputs the resultant signal to multiplication unit 65 that multiplies the input power of left channel signal Li by a predetermined factor D and outputs the result to addition unit 67.

Concurrently, power calculation unit 64 calculates the power of the input right channel signal Ri, and outputs the resultant signal to multiplication unit 66 that multiplies the input power of right channel signal Ri by the predetermined factor D and outputs the resultant signal to addition unit 67. In certain embodiments, D is set to “0.5.”

Addition unit 67 adds the output signal of multiplication unit 65 and the output signal of multiplication unit 66, and outputs the result as the LR average power to gain adjustment unit 62 of FIG. 13. The LR average power is the average value of the power of the left channel signal Li and the power of the right channel signal Ri. Here, power calculation units 63 and 64 are configured identically to power calculation unit 24 of FIGS. 6(a) and 6(b).

Gain adjustment unit 62 adjusts the gain of the sum signal that is generated by sum signal generation unit 2, and outputs the resultant signal to multiplication unit 4. Here, the gain of the sum signal is set to a magnitude that is based on the magnitude of the power ratio, e.g., Padd/Pave.

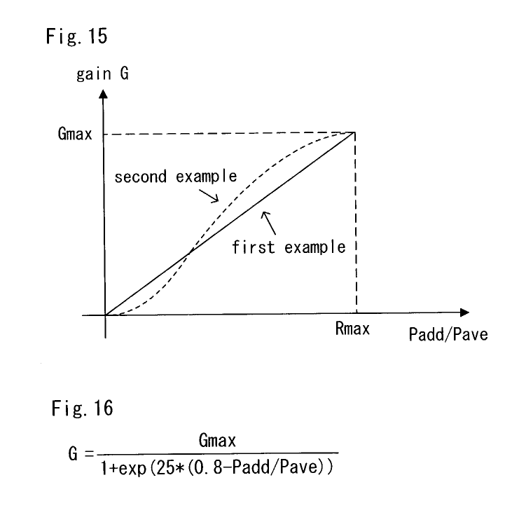

FIG. 15 is a graphical plot of a gain setting process performed by gain adjustment unit 62. In FIG. 15, the ordinate axis x indicates the gain of the sum signal that is set by gain adjustment unit 62 and the abscissa axis y indicates the power ratio, i.e., Padd/Pave.

As shown in FIG. 15, based on the first exemplary plot (e.g., the solid line), gain adjustment unit 62 sets the gain of the sum signal such that its gain is proportional to the magnitude of the power ratio, i.e., Padd/Pave.

However, whereas Padd/Pave varies from 0 to a predetermined value, such as Rmax, the gain is set to a maximum value when the value of Padd/Pave is the predetermined value, i.e., Rmax. Here, the maximum value is set to a predetermined value. In certain embodiments, the maximum value, i.e., Gmax is set to “1.”

In addition, based on the second exemplary plot (e.g., the dashed line), the gain of the sum signal may be set to increase in a curvilinear manner with an increase in the power ratio, e.g., Padd/Pave. However, even in this case, the gain is also set to the maximum value, i.e., Gmax, when the value of Padd/Pave is the predetermined value.

Hence, gain adjustment unit 62 sets the magnitude of the gain of the sum signal based on the magnitude of the power ratio (e.g., Padd/Pave) such that the gain of the sum signal is large when Padd/Pave is large and small when Padd/Pave is small.

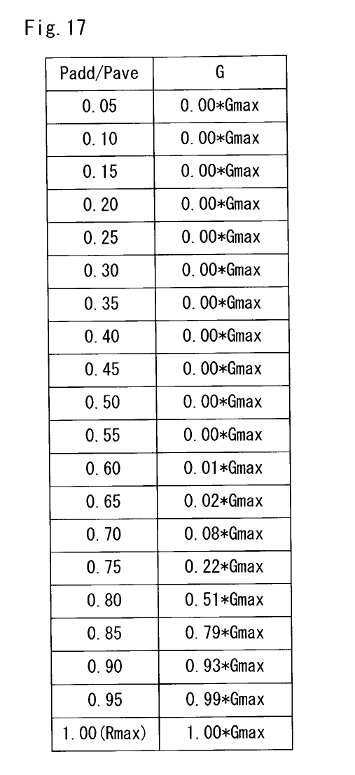

As long as the gain of the sum signal is in accordance with the present embodiment, the relationship between the gain and the Padd/Pave is not limited to the plots shown in FIG. 15. Here, the gain adjustment unit 62 may set the gain of the sum signal based on the relationship shown in FIG. 16. Alternatively, the gain adjustment unit 62 may set the gain of the sum signal by using a number from the exemplary table shown in FIG. 17. Here, the gain for a point that is not provided in the table may be determined by linear interpolation or another interpolation process.

When speech occurs, the power level of the sum signal will be large, and this power level of the sum signal will be large relative to the LR average power of the left channel signal and the right channel signal. As a result, a large Padd/Pave value provides an indication that speech has occurred, or is occurring. Conversely, a small Padd/Pave value provides an indication that speech has not occurred, or is not occurring. Hence, the power ratio, i.e., Padd/Pave can be used as an index for determining the level of speech in the audio signal.

Accordingly, by setting the gain of the sum signal to a small value when Padd/Pave is small, as shown in FIG. 15, the speech enhancement process can be suppressed when speech is absent from the audio signal. As a result, when speech is not present in the audio signal, the side effects associated with the speech enhancement process described in accordance with the prior art can be suppressed, and the stereo image can be maintained.

Concurrently, by setting the gain of the sum signal to a large value when Padd/Pave is large, as shown in FIG. 15, it is possible to enhance speech as it occurs. As a result, the speech enhancement process will be permitted to performs its primary function.

However, the gain is not set by a rigid comparison of a case in which speech occurs and a case in which speech does not occur. Rather, the gain of the sum signal is increased and decreased in a continuous manner in accordance with the magnitude of the power ratio shown in FIG. 15.

Accordingly, the gain of the sum signal is not set upon comparisons between a case in which speech occurs and a case in which speech does not occur. As a result, the difficulties associated with the process of systematically determining whether or not speech occurs or is occurring are avoided.

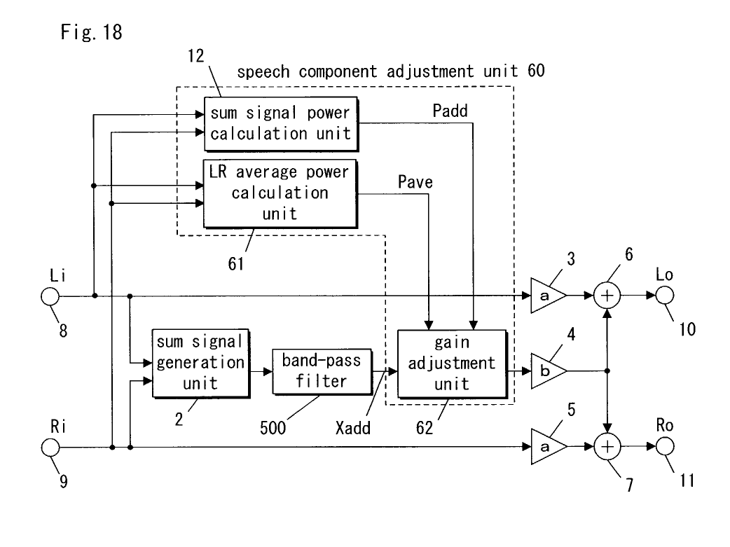

FIG. 18 is a block diagram of an alternative embodiment of the speech component enhancement device of FIG. 13. The components in FIG. 18 that are identical to those in FIG. 13 are provided with the same symbols.

The embodiment shown in FIG. 18 includes a band-pass filter 500 having a voice frequency band as the pass band that is disposed between sum signal generation unit 2 and gain adjustment unit 62 of the speech component enhancement device of FIG. 13.

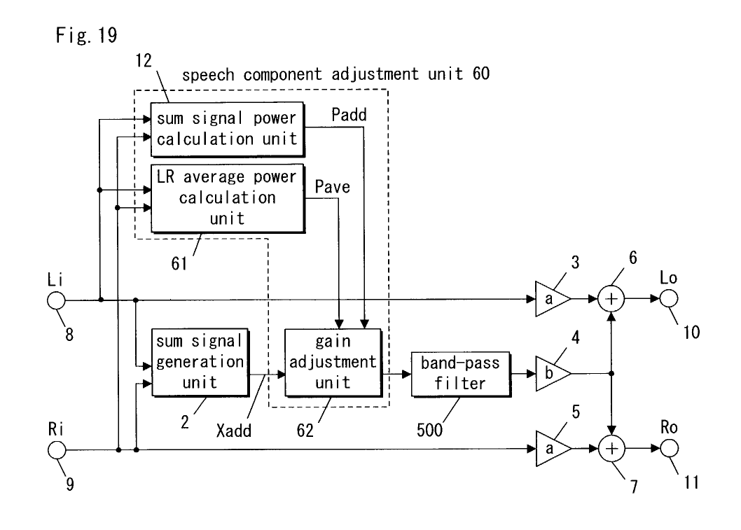

FIG. 19 is a block diagram of another embodiment of the speech component enhancement device of FIG. 13. The component in FIG. 19 that are identical to those in FIG. 13 are provided with the same symbols.

Here, the embodiment shown in FIG. 19 includes a band-pass filter 500 having a voice frequency band as the pass band that is disposed between gain adjustment unit 62 and multiplication unit 4 of the speech component enhancement device of FIG. 13.

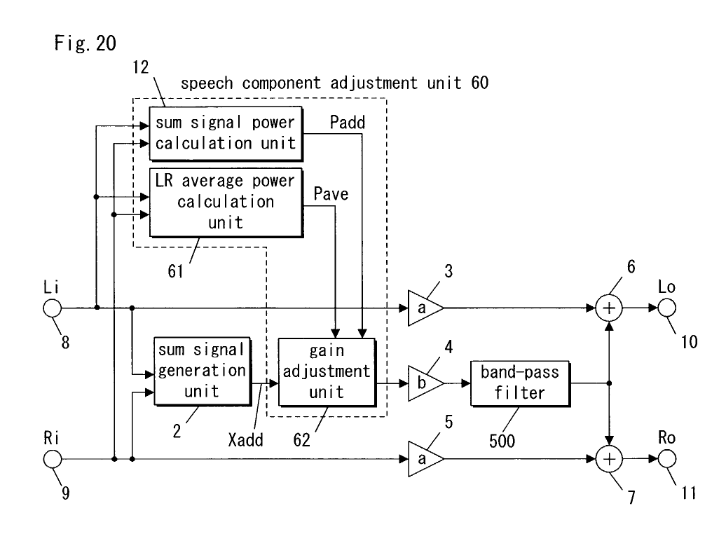

FIG. 20 is a block diagram of a further embodiment of the speech component enhancement device of FIG. 13. Here, the components in FIG. 20 that are identical to those in FIG. 13 are provided with the same symbols.

With reference to FIG. 20, the present embodiment includes a band-pass filter 500 having a voice frequency band as the pass band that is disposed at a stage that is subsequent to multiplication unit 4 of the speech component enhancement device of FIG. 13.

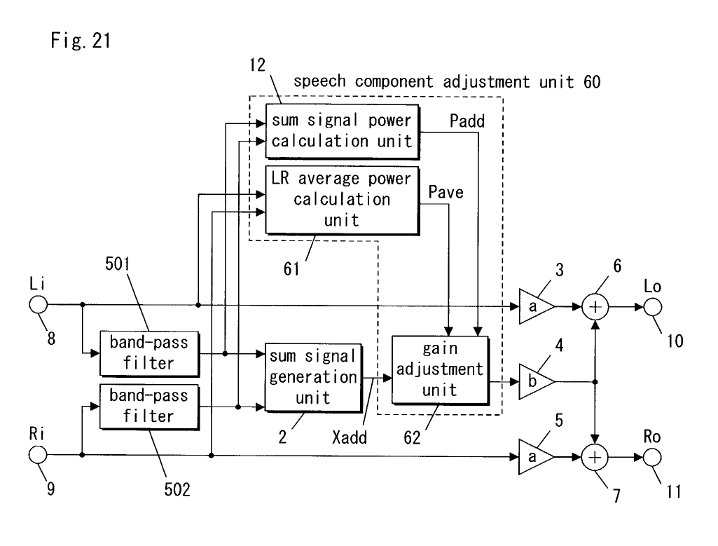

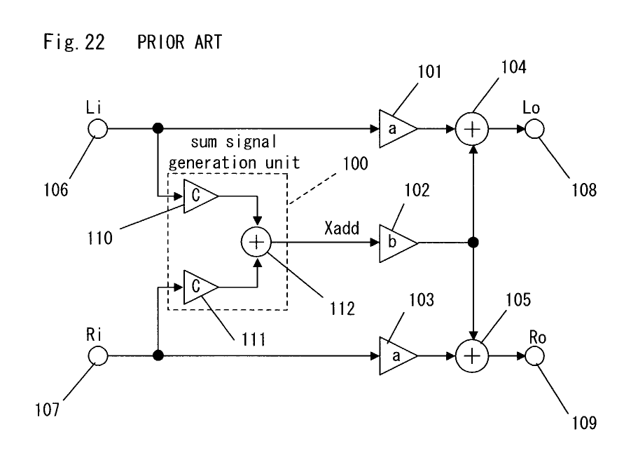

FIG. 21 is a block diagram of another embodiment of the speech component enhancement device of FIG. 13. The components in FIG. 21 that are identical to those in FIG. 13 are provided with the same symbols.

The embodiment shown in FIG. 21 includes a band-pass filter 501 having a voice frequency band as the pass band that is disposed between input terminal 8 and sum signal generation unit 2 of the speech component enhancement device of FIG. 13, and a band-pass filter 502 having a voice frequency band as the pass band that is disposed between input terminal 9 and sum signal generation unit 2 of the speech component enhancement device of FIG. 13.

By providing band-pass filters 501 and 502, each having a voice frequency band as the pass band, at stages prior to the sum signal generation unit 2 or by providing a band-pass filter 500 having a voice frequency band as the pass band at a stage subsequent to the sum signal generation unit 2 (as in the prior embodiments), the frequency band of the signal that is added by addition units 6 and 7 to the output signals of multiplication units 3 and 5 can be restricted to the voice frequency band. As a result, it becomes possible to greatly minimize the enhancement of non speech components.

It should be noted that although the present embodiments and modifications thereof were applied to two channels stereo signals, the present invention is not limited thereto and may be applied to multiple channels of stereo signals. For example, in the case of 5.1 channels, the same effects as those described above may be obtained by inputting the front left channel signal into input terminal 8 and the front right channel signal into input terminal 9.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. A speech component enhancement device for enhancing center-localized speech components, comprising:
a sum signal generation means for generating a sum signal of a left channel signal and a right channel signal;
a speech component adjustment means for referencing the left channel signal and the right channel signal and adjusting a gain of the sum signal in accordance with a level of a speech component;
a first addition means for adding said sum signal that has been gain adjusted by said speech component adjustment means and said left channel signal and outputs the result as a new left channel signal; and
a second addition means for adding said sum signal that has been gain adjusted by said speech component adjustment means and said right channel signal and outputs the result as a new right channel signal.

2. The speech component enhancement device as set forth in claim 1, wherein said speech component adjustment means comprises:
a sum signal power calculation means for calculating power of a sum signal of said left channel signal and said right channel signal;
a difference signal power calculation means for calculating the power of a difference signal of said left channel signal and said right channel signal; and
a gain adjustment means for referencing a ratio of said power of the sum signal and said power of the difference signal to adjust the gain of said sum signal generated by said sum signal generation means according to the level of the speech component.

3. The speech component enhancement device as set forth in claim 1, wherein said speech component adjustment means comprises:
a sum signal power calculation means for calculating the power of a sum signal of said left channel signal and said right channel signal;
an LR average power calculation means for calculating an average value of the power of said left channel signal and the power of said right channel signal; and
a gain adjustment means for referencing a ratio of said power of the sum signal and said average value calculated by said LR average power calculation means to adjust the gain of said sum signal generated by said sum signal generation means based on the level of the speech component.

4. The speech component enhancement device as set forth in claim 2, wherein said sum signal power calculation means comprises:
an addition means for generating a sum signal of said left channel signal and said right channel signal;
a band-pass filter having a pass band set to a voice frequency band; and
a power calculation means for calculating the power of said sum signal that passed through said band-pass filter.

5. The speech component enhancement device as set forth in claim 3, wherein said sum signal power calculation means comprises:
an addition means for generating a sum signal of said left channel signal and said right channel signal;
a band-pass filter having a pass band set to a voice frequency band; and
a power calculation means for calculating the power of said sum signal that passed through said band-pass filter.

6. The speech component enhancement device as set forth in claim 2, wherein said sum signal power calculation means comprises:
a band-pass filter having a pass band set to a voice frequency band;
an addition means for generating a sum signal of said left channel signal that passed through said band-pass filter and said right channel signal that passed through said band-pass filter; and
a power calculation means for calculating the power of said sum signal generated by said addition means.

7. The speech component enhancement device as set forth in claim 3, wherein said sum signal power calculation means comprises:
a plurality of band-pass filters, each of said plurality of band-pass filters having a pass band set to a voice frequency band;
an addition means for generating a sum signal of said left channel signal that passed through said band-pass filter and said right channel signal that passed through said band-pass filter; and
a power calculation means for calculating the power of said sum signal generated by said addition means.

8. The speech component enhancement device as set forth in claim 2, wherein
said gain adjustment means uses the ratio of said power of the sum signal and said power of the difference signal as an index to judge the strength of the speech component, and
said gain adjustment means adjusts the gain of said sum signal generated by said sum signal generation means to a magnitude that is in accordance with a magnitude of said index.

9. The speech component enhancement device as set forth in claim 3, wherein
said gain adjustment means uses the ratio of said power of the sum signal and said average value of said left channel signal and said right channel signal calculated by said LR average power calculation means as an index to determine the level of the speech component, and
said gain adjustment means adjusts the gain of said sum signal generated by said sum signal generation means to a magnitude that is in accordance with the magnitude of said index.
